(19) United States
(12) Patent Application Publication
(10) Pub. No.: US 2012/0069157 A1
(43) Pub. Date: Mar. 22, 2012

(54) DISPLAY APPARATUS

(75) Inventor: Osamu Nonaka, Sagamihara-shi (JP)

(73) Assignee: OLYMPUS IMAGING CORP., Tokyo (JP)

(21) Appl. No.: 13/232,523

(22) Filed: Sep. 14, 2011

(30) Foreign Application Priority Data
Sep. 22, 2010 (JP) 2010-212072

(51) Int. Cl. H04N 13/02; H04N 13/04

(52) U.S. Cl. 348/51; 348/46; 348/E13.074; 348/E13.075

(57) ABSTRACT

A display apparatus including a display unit that displays moving images corresponding to moving image data consisting of multiple two-dimensional images and three dimensional images that are sequentially generated chronologically. A touch panel is provided on a display screen of the display unit and receives an input of a signal corresponding to a position touched by an external object. A setting unit sets a subject contained in the moving images and specified according to an input signal received by the touch panel. A motion detector detects motion of the subject, which is set by the subject setting unit, on the basis of successive two of the two-dimensional images or the three dimensional images that are generated chronologically. A display controller causes the display unit to display the moving images as the three-dimensional images.

### CROSS-REFERENCE TO RELATED APPLICATIONS

This application is based upon and claims the benefit of priority from Japanese Patent Application No. 2010-212072, filed on Sep. 22, 2010, the entire contents of which are incorporated herein by reference.

### BACKGROUND OF THE INVENTION

1. Field of the Invention

The present invention relates to a display apparatus that displays a two-dimensional image or a three-dimensional image.

2. Description of the Related Art

In recent years, display apparatuses have been known that acquire multiple types of image data by capturing images of the same subject by using a digital stereo camera and that display a three-dimensional image that a user can see three-dimensionally by using the parallax of the subject contained in the acquired multiple types of image data.

Regarding such display apparatuses, a technology is known in which a moving image that is displayed by a display monitor can be switched between a three-dimensional image (hereinafter, “3D image”) and a two-dimensional image (hereinafter, “2D image”) depending on the distance between the display apparatus and the subject (see Japanese Laid-open Patent Publication No. 2010-161492). In this technology, by displaying, on the display monitor, a moving image as a 2D image when the distance between the subject of which images are captured and the display apparatus is equal to or less than a threshold, the subject image is prevented from being displayed as blurred double images.

### SUMMARY OF THE INVENTION

A display apparatus according to an aspect of the present invention includes a display unit that displays moving images corresponding to moving image data that is made up of multiple two-dimensional images and three-dimensional images that are sequentially generated chronologically; a touch panel that is provided on a display screen of the display unit and that receives an input of a signal corresponding to a position touched by an external object; a setting unit that sets, as a subject of which motion is to be tracked in the moving images displayed by the display unit, a subject that is contained in the moving images and that is specified according to an input signal that is received by the touch panel; a motion detector that, when the subject setting unit sets the subject to be tracked, detects motion of the subject, which is set by the subject setting unit, on the basis of successive two of the two-dimensional images or the three-dimensional images that are generated chronologically; and a display controller that, when the motion detector detects motion of the subject to be tracked, causes the display unit to display the three-dimensional images as the moving images.

A display apparatus according to another aspect of the present invention includes a display unit that selectively displays two-dimensional moving images and three-dimensional moving images; a motion detector that detects motion of a subject contained in the moving images; and a display controller that, when the motion detector detects the motion of the subject contained in the two-dimensional moving images being displayed by the display unit, causes the display unit to display the three-dimensional moving images as the moving images.

A display apparatus according to still another aspect of the present invention includes a display unit that selectively displays two-dimensional moving images and three-dimensional moving images; a motion detector that detects motion of a subject contained in the moving images; and a display controller that, when the motion detector detects the motion of the subject contained in the two-dimensional moving images being displayed by the display unit, converts the two-dimensional moving images into the three-dimensional moving images and causes the display unit to display the three-dimensional moving images as the moving images.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a configuration of a display apparatus according to a first embodiment of the present invention;

FIG. 2 is a schematic diagram of a configuration of a display unit of the display apparatus according to the first embodiment of the present invention;

FIG. 3 is a schematic diagram illustrating a situation in which an imaging unit of the display apparatus according to the first embodiment of the present invention generates two types of image data where one horizontal ends of two fields of view match;

FIG. 4 contains diagrams of an example of images corresponding to two types of image data, which are generated by the imaging unit in the situation in FIG. 3, where one horizontal ends of two fields of view with respect to the subject match;

FIG. 5 is a diagram of an example of an image in which a right-eye image and a left-eye image generated by the imaging unit in the situation in FIG. 3 are virtually superimposed;

FIG. 6 is a diagram illustrating a relationship between the distance from the imaging unit to the subject and the position of the subject in the image in the situation in FIG. 3;

FIG. 7 is a flowchart of an overview of processes performed by the display apparatus according to the first embodiment of the present invention;

FIG. 8 is a flowchart of an overview of a live view image switch process in FIG. 7;

FIG. 9 is a diagram of an example of a 2D image that is displayed by the display unit;

FIG. 10 is a diagram illustrating a user performing an operation for setting a subject in the 2D image that is displayed by the display unit;

FIG. 11 contains diagrams illustrating an overview of a method in which a background separator causes a three-dimensional image generator to generate a 3D image in which a subject to be tracked is enhanced with respect to the background;

FIG. 12 is a diagram of an example of a virtual 3D of the 3D image displayed by the display unit and that the user recognizes;

FIG. 13 is a flowchart of an overview of a playback display process in FIG. 7;

FIG. 14 is a block diagram of a configuration of a display apparatus according to a second embodiment of the present invention;

FIG. 15 contains diagrams of chronological images corresponding to multiple types of image data that, when the display apparatus according to the second embodiment of the present invention captures moving images, an imaging unit sequentially generates;

FIG. 16 contains diagrams illustrating a method in which a display controller of the display apparatus according to the second embodiment of the present invention displays a 3D image; and

FIG. 17 is a flowchart of an overview of a live view image switch process performed by the display apparatus according to the second embodiment of the present invention.

### DETAILED DESCRIPTION OF THE PREFERRED EMBODIMENTS

### First Embodiment

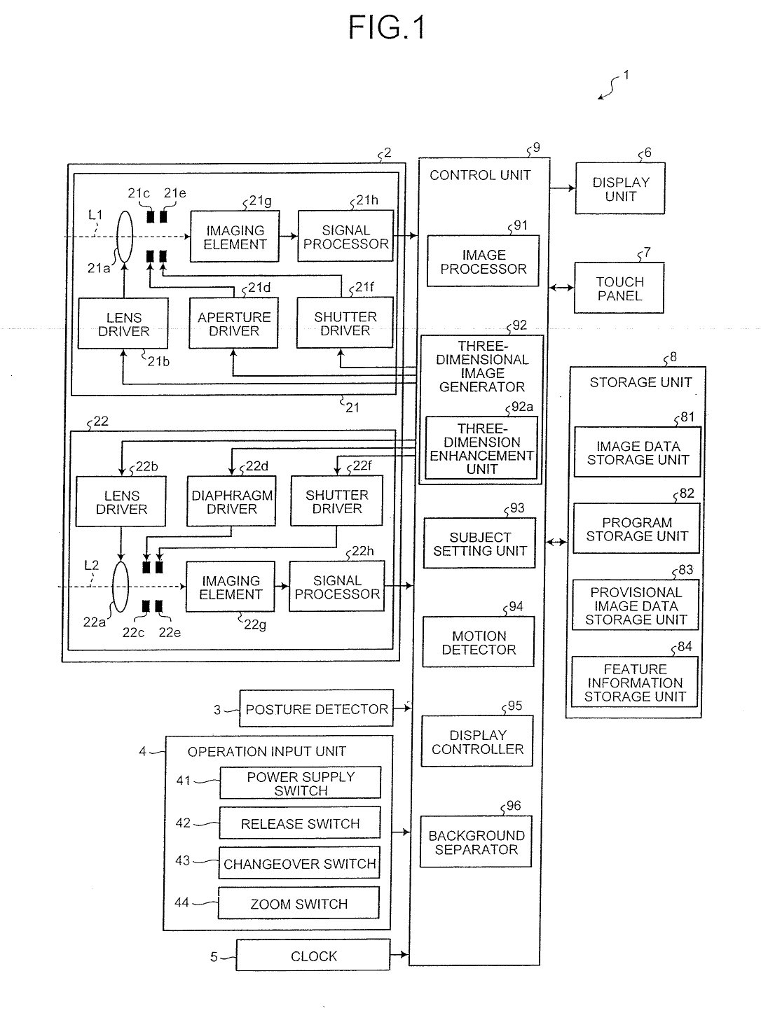

FIG. 1 is a block diagram of a configuration of a display apparatus according to a first embodiment of the present invention. In the first embodiment, a digital camera that incorporates a display apparatus 1 will be described as an example. As illustrated in FIG. 1, the display apparatus 1 includes an imaging unit 2 that captures images in different positions and thus generates two types of image data where one horizontal ends of two fields of view match; a posture detector 3 that detects the posture of the display apparatus 1; an operation input unit 4 that receives inputs of various types of information of the display apparatus 1; a clock 5 that has a function of determining the date at which an image is captured and a timer function; a display unit 6 that displays a three-dimensional image or a two-dimensional image; a touch panel 7 that receives an input of a signal corresponding to a externally touched position; a storage unit 8 that stores various types of information including image data generated by the imaging unit 2; and a control unit 9 that controls operations of the display apparatus 1.

The imaging unit 2 includes a first imaging unit 21 and a second imaging unit 22. The first imaging unit 21 and the second imaging unit 22 are arranged side by side such that optical axes L1 and L2 are parallel or at a predetermined angle.

The first imaging unit 21 includes a lens unit 21a, a lens driver 21b, a diaphragm 21c, an diaphragm driver 21d, a shutter 21e, a shutter driver 21f, an imaging element 21g, and a signal processor 21h. The lens unit 21a includes a focus lens and a zoom lens and focuses light from a predetermined field of view. The lens driver 21b includes a DC motor and changes the focus position and the focal length of the lens unit 21a by moving the focus lens and the zoom lens of the lens unit 21a along the optical axis L1. The diaphragm 21c adjusts the exposure by limiting the amount of incident light that is focused by the lens unit 21a. The diaphragm driver 21d includes a stepping motor and drives the diaphragm 21c. The shutter 21e sets the state of the imaging element 21g to a light-emitting state or a light-blocked state. The shutter driver 21f includes a stepping motor and drives the shutter 21e in response to a release signal. The imaging element 21g is realized by using a charge coupled device (CCD) and a complementary metal oxide semiconductor (CMOS) that receive the light that is focused by the lens unit 21a and converts the light to electric signals (analog signals). The imaging element 21g outputs the converted electric signals to the signal processor 21h. The signal processor 21h performs a signal process of, for example, amplifying the electric signals, which are output from the imaging element 21g, then performs an A/D conversion to convert the signals to digital image data, and outputs the digital image data to the control unit 9.

The second imaging unit 22 is realized by using the same configuration as that of the first imaging unit 21. The second imaging unit 22 includes a lens unit 22a, a lens driver 22b, a diaphragm 22c, an diaphragm driver 22d, a shutter 22e, a shutter driver 22f, an imaging element 22g, and a signal processor 22h.

The posture detector 3 includes an accelerometer and detects the posture of the display apparatus 1 by detecting the acceleration of the display apparatus 1. Specifically, the posture detector 3 detects the posture of the display apparatus 1 with the horizontal plane being the reference.

The operation input unit 4 includes a power supply switch 41 that switches on or off the power supply of the display apparatus 1; a release switch 42 that inputs a release signal giving an instruction to capture a still image; a changeover switch 43 for switching between various shooting modes and various types of setting of the display apparatus 1; and a zoom switch 44 that performs a zoom operation of the imaging unit 2.

The clock 5 generates a time signal based on which the display apparatus 1 operates. Thus, the control unit 9 can set the time of acquiring image data or the time of exposure of the imaging elements 21g and 22g.

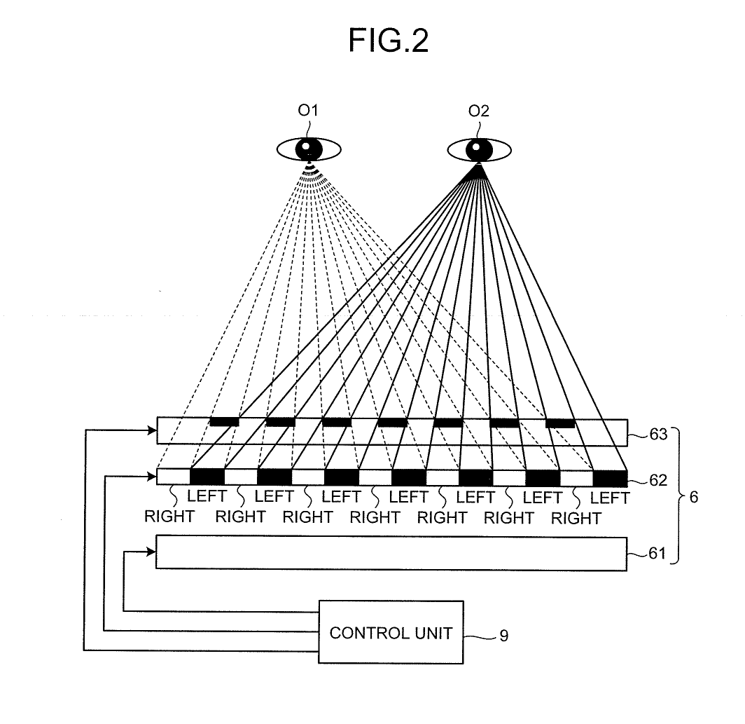

FIG. 2 is a schematic diagram of a configuration of the display unit 6. As illustrated in FIG. 2, the display unit 6 includes a backlight 61, a display panel 62, and a parallax barrier 63. The backlight 61 includes a light emitting diode (LED) and emits light for displaying an image from the back side. The display panel 62 includes a display panel including liquid crystals or an organic electro luminescence (EL) diode. The parallax barrier 63 consists of, for example, liquid crystals and is superimposed on the top surface of the display panel 62. The parallax barrier 63 is provided with slits at intervals narrower than each pixel of the display panel 62, which separates images corresponding respectively to the right eye O1 and the left eye O2 of the user. In the first embodiment, a parallax barrier system is applied to the parallax barrier 63. In the first embodiment, instead of the parallax barrier 63, a lens sheet in which a lenticular lens is superimposed may be superimposed on the top surface of the display panel 62.

When the control unit 9 inputs 3D image data, in the display unit 6 having the above-described configuration, the display panel 62 sequentially displays a right-eye image and a left-eye image alternately from the left-end pixel in the horizontal direction under the control of the control unit 9 and the parallax barrier 63 separates the light emitted from each pixel of the display panel 62. Accordingly, the right image reaches only the right eye O1 and the left image reaches only the left eye O2. Accordingly, the user can virtually and three-dimensionally see a 3D image displayed by the display unit. When the display unit 6 changes the display mode from a 3D image to a 2D image, the voltage applied to the parallax barrier 63 is switched from the on state to the off state and thus the parallax barrier 63 turns from the light-blocked state to the light-emitting state. Accordingly, any one of the right-eye image and the left-eye image is output to the display panel 62 so that a 2D image can be displayed.

The touch panel 7 is superimposed on the display screen of the display unit 6. The touch panel 7 detects a position touched by the user according to information displayed on the display unit 6 and receives an input of an operation signal corresponding to the touched position. In general, there are resistive touch displays, capacitive touch displays, and optical touch displays. In the first embodiment, any touch display can be used. In the first embodiment, the touch panel 7 functions as an input unit.

The storage unit 8 includes an image data storage unit 81 that stores data of images captured by the imaging unit 2; a program storage unit 82 that stores various programs that are executed by the display apparatus 1; a provisional image data storage unit 83 that temporarily stores data of images that are captured by the imaging unit 2 and various types of setting of the display apparatus 1; and a feature information storage unit 84 that stores feature information on the subject that is set by the user. The storage unit 8 is realized by using a semiconductor memory, such as a flash memory, a random access memory (RAM), or a read only memory (ROM), which is securely provided in the display apparatus 1. The storage unit 8 may have, in addition to a function of storing information in a storage medium, such as a memory card that is externally attached, a function of a recording medium interface that reads information stored in the storage medium. The feature information is information that contains information on the positions of face parts, such as the eyes and nose, of the subject. The feature information storage unit 84 may store feature information on an animal, such as a dog or a cat, as a subject.

The control unit 9 is realized by using, for example, a central processing unit (CPU). The control unit 9 generally controls operations of the display apparatus 1 in a way that it reads programs from the program storage unit 82 of the storage unit 8 according to an operation signal from the operation input unit 4 and executes the programs to issue instructions to each unit of the display apparatus 1 and transfer data. The control unit 9 includes an image processor 91, a three-dimensional image generator 92, a subject setting unit 93, a motion detector 94, a display controller 95, and a background separator 96.

The image processor 91 performs various image processes on the left-eye image data and the right-eye image data that are respectively output from the signal processors 21h and 22h and then outputs the processed image data to the image data storage unit 81 of the storage unit 8. Specifically, the image processor 91 performs processes, such as an edge enhancement, a color correction, and a γ correction, on the left-eye image data and the right-eye image data that are respectively output from the signal processors 21h and 22h.

The three-dimensional image generator 92 generates a 3D image by cutting out an image with a predetermined aspect ratio of, for example, 16:9 from each of the processed left-eye image data and the right-eye image data. The aspect ratio with which an image is cut out from each of the left-eye image data and the right-eye image data by the three-dimensional image generator 92 may be set via the changeover switch 43. The three-dimensional image generator 92 includes a three-dimension enhancement unit 92a. The three-dimension enhancement unit 92a generates a 3D image in which the subject is enhanced with respect to the background by cutting out a subject image corresponding to the subject to be tracked from each of the left-eye image data and the right-eye image data.

The subject setting unit 93 sets a subject that is contained in a 2D image and a 3D image displayed by the display unit 6 and of which motion is tracked in moving images. Specifically, the subject setting unit 93 sets, as a subject to be tracked, a subject that is contained in moving images displayed by the display unit 6 and that is specified according to an input signal received by the touch panel 7. The subject setting unit 93 may set, as a subject to be tracked in moving images, a subject of which the face is detected by a face detector (not shown).

When the subject setting unit 93 sets a subject to be tracked, the motion detector 94 detects motion of the subject to be tracked, which is set by the subject setting unit 93, on the basis of adjacent 2D images or adjacent 3D images. Specifically, the motion detector 94 detects motion of the subject by obtaining a motion vector in the direction in which the subject moves in adjacent images, which are sequentially generated by the imaging unit 2. For example, the motion detector 94 calculates a motion vector in an area of the subject by performing a pattern matching on the area of the subject between the latest image that is constantly output from the imaging unit 2 and stored in the provisional image data storage unit 83 and the image that is currently generated by the imaging unit 2. Furthermore, in order to accurately detect motion of the subject, the motion detector 94 may detect a motion vector of the subject in a way that, in order to detect motion of the subject accurately, the area of the subject is divided into multiple areas (macro blocks) and a motion vector is calculated for each of the divided areas. The motion detector 94 may detect motion of the subject by combining the shape of the subject, the contrast, and the color. It is satisfactory if the motion detector 94 uses any one of the right-eye image and the left-eye image when motion of the subject, which is set by the subject setting unit 93, is detected by using 3D images.

The display controller 95 causes the display unit 6 to display a 3D image or a 2D image. Specifically, when the display controller 95 causes the display unit 6 to display a 3D image, the display controller 95 divides a left-eye image and a right-eye image of a 3D image, which is generated by the three-dimensional image generator 92, into stripes and then causes the display unit 6 to display the 3D image such that each pixel of the divided 3D image is alternately arranged horizontally on the display screen of the display unit 6. In contrast, when the display controller 95 causes the display unit 6 to display a 2D image, the display controller 95 turns the power supply to the parallax barrier 63 from the on state to the off state in order to turn the slits of the parallax barrier 63 of the display unit 6 from the light-blocked state to the light-emitting state and the display controller 95 then causes the display unit 6 to display only one of the left-eye image and the right-eye image. The display controller 95 causes the display unit 6 to display a 3D image or a 2D image according to the result of the detection of the motion detector 94. Specifically, when the motion detector 94 detects motion of the subject, which is set by the subject setting unit 93, the display controller 95 causes the display unit 6 to display a moving image as a 3D image in which the subject virtually protrudes in a direction orthogonal to the display screen of the display unit 6.

The background separator 96 separates, as a subject image, the subject to be tracked, which is set by the subject setting unit 93, from the background image in a moving image. Specifically, the background separator 96 separates, as a subject image, the subject to be tracked from the background image in the moving image by setting a position in which the three-dimensional image generator 92 trims an image in each of the left-eye image data and the right-eye image data based on the area in which the subject to be tracked, which is set by the subject setting unit 93, exists in the moving image. In this manner, the background separator 96 causes the three-dimensional image generator 92 to generate a 3D image in which a subject image protrudes from a background image.

A 3D image is generated by trimming an image with an aspect ratio of, for example, 16:9 from each of the left-eye image data and the right-eye image data.

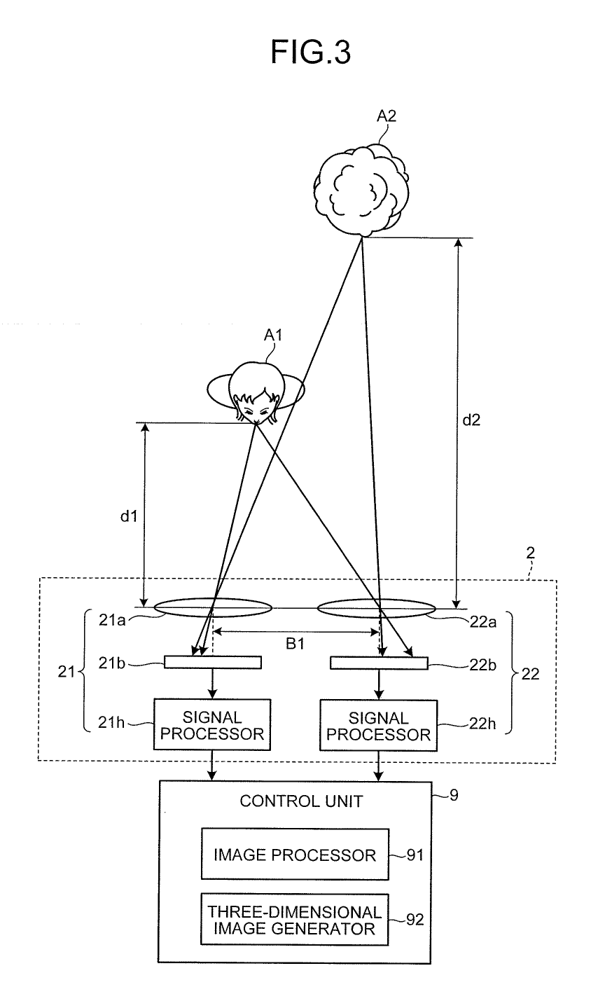

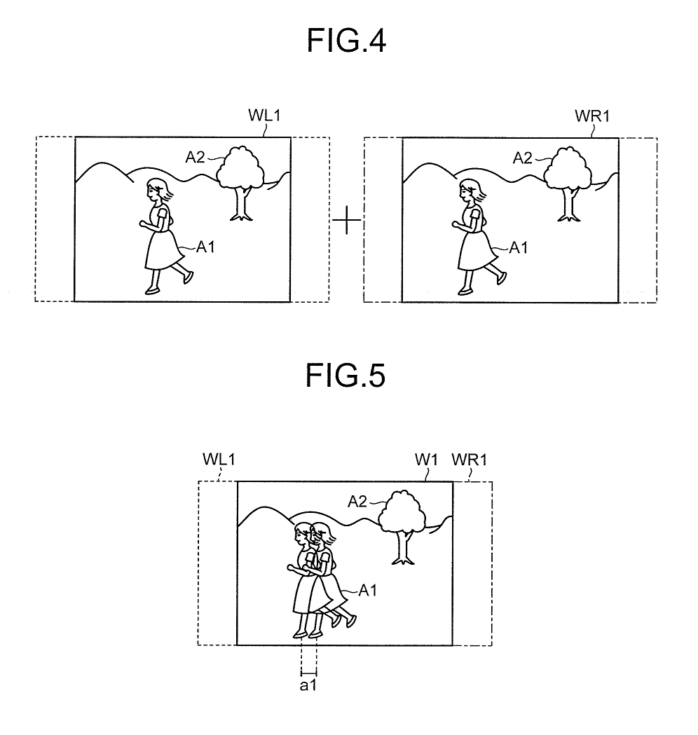

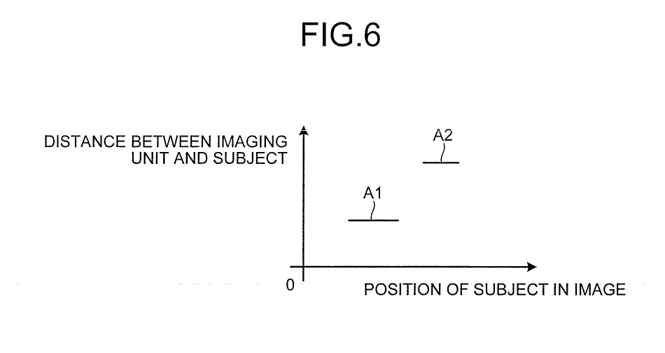

Regarding the display apparatus 1 having the above-described configuration, a situation will be described in which the imaging unit 2 generates two types of image data where one horizontal ends of two fields of view match. FIG. 3 is a schematic diagram illustrating a situation in which the imaging unit 2 generates data two types of image data where one horizontal ends of two fields of view match. FIG. 4 contains diagrams of an example of two images corresponding respectively to the two types of image data that are generated by the imaging unit in the situation in FIG. 3. In FIG. 4, an image WR1 is the right-eye image that is generated by the three-dimensional image generator 92 by trimming an image from the image corresponding to the right-eye image data, which is generated by the first imaging unit 21, and an image WL1 is the left-eye image that is generated by the three-dimensional image generator 92 by trimming an image from the image corresponding to the left-eye image data, which is generated by the second imaging unit 22. FIG. 5 is a diagram of an example of an image in which the right-eye image and the left-eye image, which are generated by the three-dimensional image generator 92 in the situation in FIG. 3, are virtually superimposed. FIG. 6 is a diagram illustrating the relationship between the distance from the imaging unit 2 to the subject in the situation illustrated in FIG. 3 and the position of the subject in the image. In FIG. 6, the horizontal axis represents the position of the subject in an image W1 where the left end is the origin and the vertical axis represents the distance between the imaging unit 2 and the subject. In FIG. 4 and FIG. 5, the dashed lines and the dashed-dotted lines represent an image area corresponding to image data that is generated by the first imaging unit 21 and the second imaging unit 22, respectively.

As illustrated in FIG. 3, the imaging unit 2 generates right-eye image data and left-eye image data in a way that the first imaging unit 21 and the second imaging unit 22 that are arranged with a distance of (base length) B1 between them each capture an image of a subject A1 (distance d1) and an image of a subject A2 (distance d2) with different distances from the imaging unit 2. Thereafter, the three-dimensional image generator 92 generates a right-eye image WR1 and a left-eye image data WL2 by trimming images with the predetermined aspect ratio (16:9) from the right-eye image data and the left-eye image data, respectively, on which image processes are performed by the image processor 91 (see FIG. 5). As illustrated in FIG. 6, the distance between the imaging unit 2 and the subject A2 is larger than the distance between the imaging unit 2 and the subject A1. Thus, the areas of the subject A2 almost match. In contrast, the areas of the subject A1 do not match and there is a parallax a1 with respect to the subject A1.

As described above, in the right-eye image WR1 and the left-eye image WL1, the parallax of a subject (the subject A1) with a small distance from the imaging unit 2 in a 3D image is large and the parallax of a subject (the subject A2) with a large distance from the imaging unit 2 in a 3D image is small. Thus, in the first embodiment, the three-dimensional image generator 92 generates a 3D image by trimming the right-eye image WR1 and the left-eye image WL1 with a parallax with respect to the subject respectively from the right-eye image data and the left-eye image data, and the display controller 95 then causes the display unit 6 to display the 3D image. Accordingly, the user can see the 3D image in which the subject A1 virtually protrudes in a direction orthogonal to the display screen of the display unit 6.

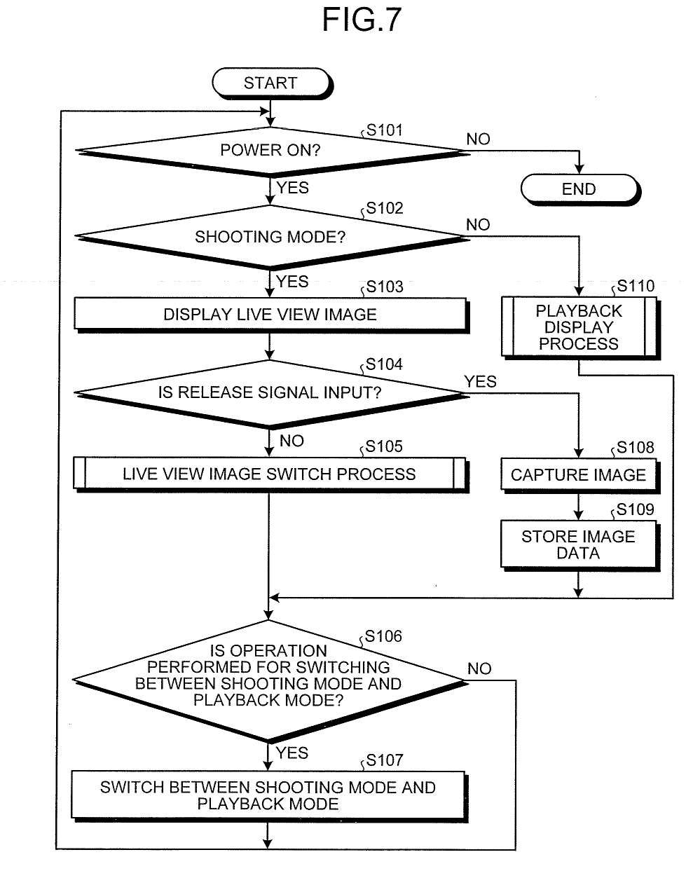

The processes performed by the display apparatus 1 according to the first embodiment will be described below. FIG. 7 is a flowchart of an overview of processes performed by the display apparatus 1.

As illustrated in FIG. 7, first, the control unit 9 determines whether the power supply of the display apparatus 1 is on (step S101). When the power supply of the display apparatus 1 is on (YES at step S101), the display apparatus 1 goes to step S102, which will be described below. In contrast, when the power supply of the display apparatus 1 is not on (NO at step S101), the display apparatus 1 ends the process.

The control unit 9 then determines whether the display apparatus 1 is set to the shooting mode (step S102). When the display apparatus 1 is set to the shooting mode (YES at step S102), the display apparatus 1 goes to step S103. In contrast, when the display apparatus 1 is not set to the shooting mode (NO at step S102), the display apparatus 1 goes to step S110.

At step S103, the display controller 95 causes the display unit 6 to display a live view image as a 2D image corresponding to any one of the right-eye image data and the left-eye image data, which are sequentially generated at a predetermined small time interval by the imaging unit, or a live view image as a 3D image using the right-eye image data and the left-eye image data.

The control unit 9 determines whether the user operates the release switch 42 so that a release signal giving an instruction to capture an image is input (step S104). When a release signal giving an instruction to capture an image is not input (NO at step S104), the display apparatus 1 performs a live view image switch process to switch the mode from displaying live view images, which will be described below (step S105).

Thereafter, the control unit 9 determines whether the user operates the changeover switch 43 so that an operation is performed for switching between a shooting mode and a playback mode of the display apparatus 1 (step S106). Specifically, the controller determines whether the user operates the changeover switch 43 so that a switch signal is input giving an instruction to switch between the shooting mode and the playback mode of the display apparatus 1. When the user does not perform an operation for switching between the shooting mode and the playback mode of the display apparatus 1 (NO at step S106), the display apparatus 1 returns to step S101. In contrast, when the user performs an operation for switching between the shooting mode and the playback mode of the display apparatus 1 (YES at step S106), the control unit 9 switches between the shooting mode and the playback mode of the display apparatus 1 in accordance with the contents of the switch operation performed by the user (step S107), and the display apparatus 1 returns to step S101.

A case at step S104 will be described below where the user operates the release switch 42 so that a release signal is input giving an instruction to capture an image (YES at step S104). In this case, the display apparatus 1 captures an image, for example, captures a still image or a moving image corresponding to the release signal (step S108) and stores the data of the captured image in the image data storage unit 81 (step S109). The display apparatus 1 then goes to step S106.

A case at step S102 will be described where the display apparatus 1 is not set to the shooting mode (NO at step S102). In this case, the control unit 9 performs a playback display process for playing the data of the captured images (step S110), and the display apparatus 1 then goes to step S106.

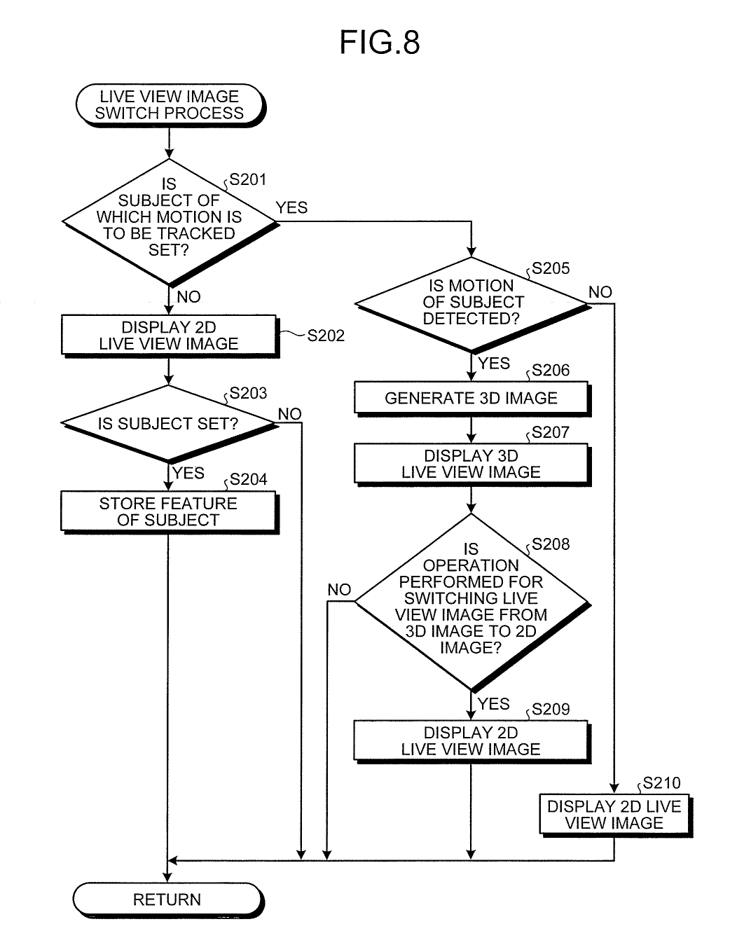

A process for switching the live view image at step S105 in FIG. 7 will be described below. FIG. 8 is a flowchart of an overview of the live view image switching process.

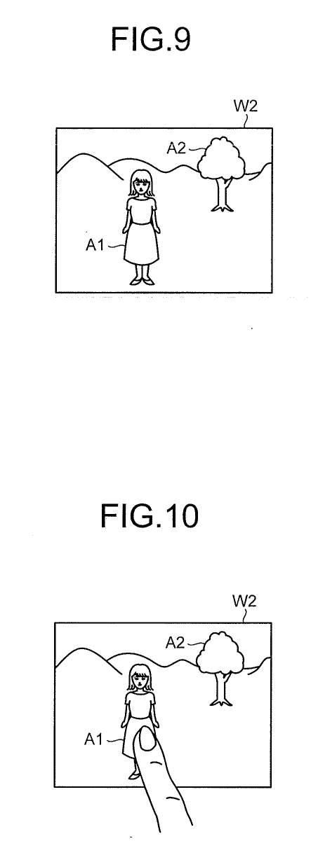

As illustrated in FIG. 8, first, the control unit 9 determines whether the user sets a subject of which motion is to be tracked in live view images that are displayed by the display unit 6 (step S201). Specifically, the control unit 9 determines whether the feature information on the subject of which motion is to be tracked in live view images, which are displayed by the display unit 6, is stored in the feature information storage unit 84. When the user does not set a subject of which motion is to be tracked in live view images, which are displayed by the display unit 6 (NO at step S201), the display controller 95 causes the display unit 6 to display a live view image of a 2D image corresponding to any one of the right-eye image data and the left-eye image data, which are sequentially generated at the certain small time interval by the imaging unit 2 (step S202). Specifically, as illustrated in FIG. 9, the display controller 95 causes the display unit 6 to display the image W2 that is a 2D image.

The control unit 9 then determines whether the subject setting unit 93 sets a subject according to an input signal that is received by the touch panel 7 (step S203). Specifically, as illustrated in FIG. 10, the control unit 9 determines whether the user touches the subject A1 in the image W2, which is displayed by the display unit 6, so that the subject A1 is set according to an input signal received by the touch panel 7. When no subject is set according to an input signal received by the touch panel 7 (NO at step S203), the display apparatus 1 returns to the main routine in FIG. 7. In contrast, when a subject is set according to an input signal received by the touch panel 7 (YES at step S203), the control unit 9 causes the feature information storage unit 84 to store the features of the subject that is set according to the input signal received by the touch panel 7 (step S204) and the display apparatus 1 returns to the main routine in FIG. 7.

A case at step S201 will be described below where a subject of which motion is to be tracked in live view images that are displayed by the display unit 6 is set according to a signal received by the touch panel 7 (YES at step S201). In this case, the control unit 9 determines whether the motion detector 94 detects motion of the subject, which is set according to the signal received by the touch panel 7 (step S205). When the motion detector 94 detects motion of the subject, which is set according to the signal received by the touch panel 7 (YES at step S205), the background separator 96 causes the three-dimensional image generator 92 to generate a 3D image in which the subject to be tracked is enhanced with respect to the background (step S206).

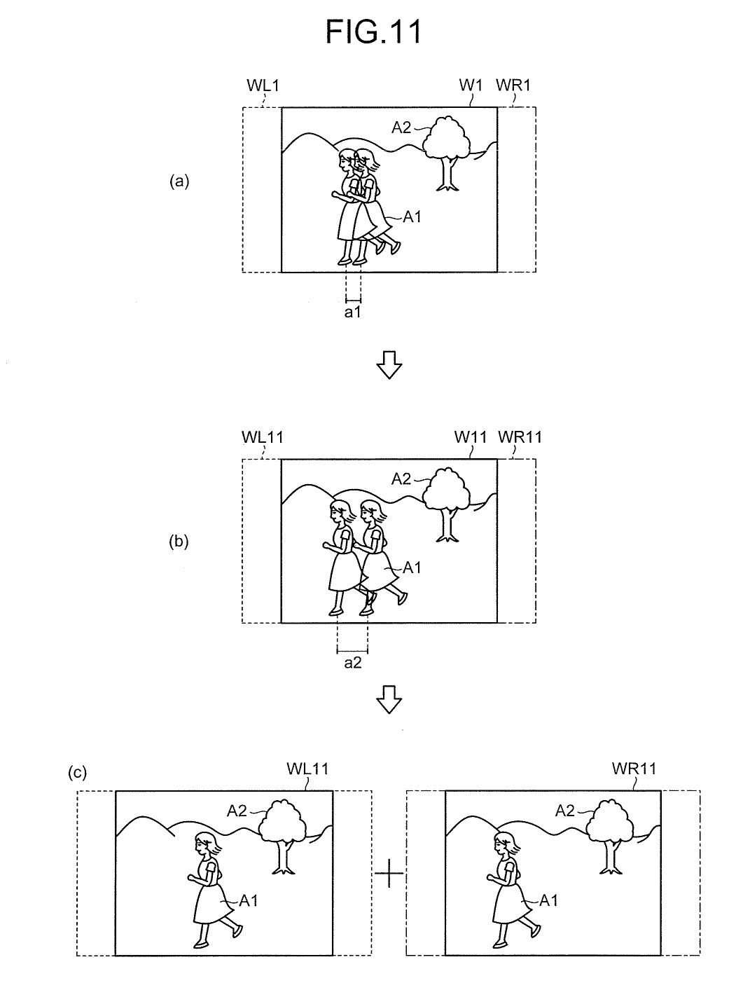

FIG. 11 contains diagrams illustrating an overview of a method in which the background separator 96 causes the three-dimensional image generator 92 to generate a 3D image in which a subject to be tracked is enhanced with respect to the background.

As illustrated in FIG. 11, first, the background separator 96 matches the screen periphery in the right-eye image WR1 and the screen periphery in the left-eye image WL2 (see (a) of FIG. 11). While the background separator 96 separates the matched portions as background images from the right-eye image WR1 and the left-eye image WL1, the background separator 96 causes the three-dimensional image enhancement unit 92a of the three-dimensional image generator 92 to perform a process for displacing (parallax a2) the positions of the portions (portions of the subject to be tracked) that do not match and have a difference (parallax a1) (see (b) of FIG. 11).

In other words, the background separator 96 causes the three-dimensional image generator 92 to generate a subject image from each of the left-eye image WL2 and the right-eye image WR2 in a way that the display positions (trimming positions) are displaced in a direction such that the parallax of the subject A1 moving in the left-eye image WL2 and the right-eye image WR2 is increased and there is a difference (parallax a2) in the display position (see (c) of FIG. 11). By displaying the right and left subject images A1, which are generated by the three-dimensional image enhancement unit 92a, the display controller 95 allows the user to virtually see the 3D image in which the subject image A1 to be tracked protrudes in relation to the background image. In this case, the amount of parallax is adjusted to be the recognizable parallax a2 regardless of the parallax a1. For example, the width of the screen may be 2.9% according to p. 22 of “3D security guideline for wide use of user-friendly 3D (amended on 20 Apr., 2010)” by 3D CONSORTIUM (3DC) GUIDELINE DIVISION (retrieved on 28 Apr., 2011) <http://www.3dc.gr.jp/jp/scmt_wg_rep/3dc_guideJ_{—}20100420.pdf>. In addition, the parallax a1 may be multiplied by a predetermined amount for enhancement (for example, twice).

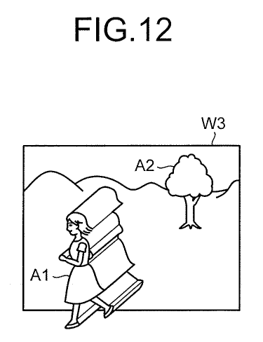

Thereafter, by using the 3D image generated by the three-dimensional image generator 92, the display controller 95 causes the display unit 6 to display a live view image of the 3D image in which the subject to be tracked protrudes virtually in a direction orthogonal to the display panel 62 (step S207). Specifically, as illustrated in FIG. 12, the display controller 95 causes the display unit 6 to display a live view image of a 3D image W3 in which the subject A1 to be tracked protrudes virtually in a direction orthogonal to the display panel 62. In FIG. 12, the display unit 6 represents a representative 3D image of multiple live view images that are displayed sequentially by the display unit 6.

Subsequently, the control unit 9 determines whether the user performs an operation for switching the live view image, which is displayed by the display unit 6, from the 3D image to a 2D image (step S208). Specifically, the control unit 9 determines whether the user operates the changeover switch 43 so that a switch signal is input giving an instruction to switch the live view image, which is displayed by the display unit 6, from the 3D image to a 2D image. When the user does not perform an operation for switching the live view image, which is displayed by the display unit 6, from the 3D image to a 2D image (NO at step S208), the display apparatus 1 returns to the main routine in FIG. 7. In contrast, when the user performs an operation for switching the live view image, which is displayed by the display unit 6, from the 3D image to a 2D image (YES at step S208), the display controller 95 causes the display unit 6 to display a live view image of a 2D image corresponding to any one of the right-eye image data and the left-eye image data, which are sequentially generated by the imaging unit 2 at the predetermined small time interval (step S209). The display apparatus 1 then returns to the main routine in FIG. 7.

A case at step S205 will be described where the motion detector 94 does not detect any motion of the subject, which is set according to the signal received by the touch panel 7 (NO at step S205). In this case, the display controller 95 causes the display unit 6 to display a live view image of a 2D image corresponding to any one of the right-eye image data and the left-eye image data, which are sequentially generated by the imaging unit 2 (step S210), and the display apparatus 1 returns to the main routine in FIG. 7.

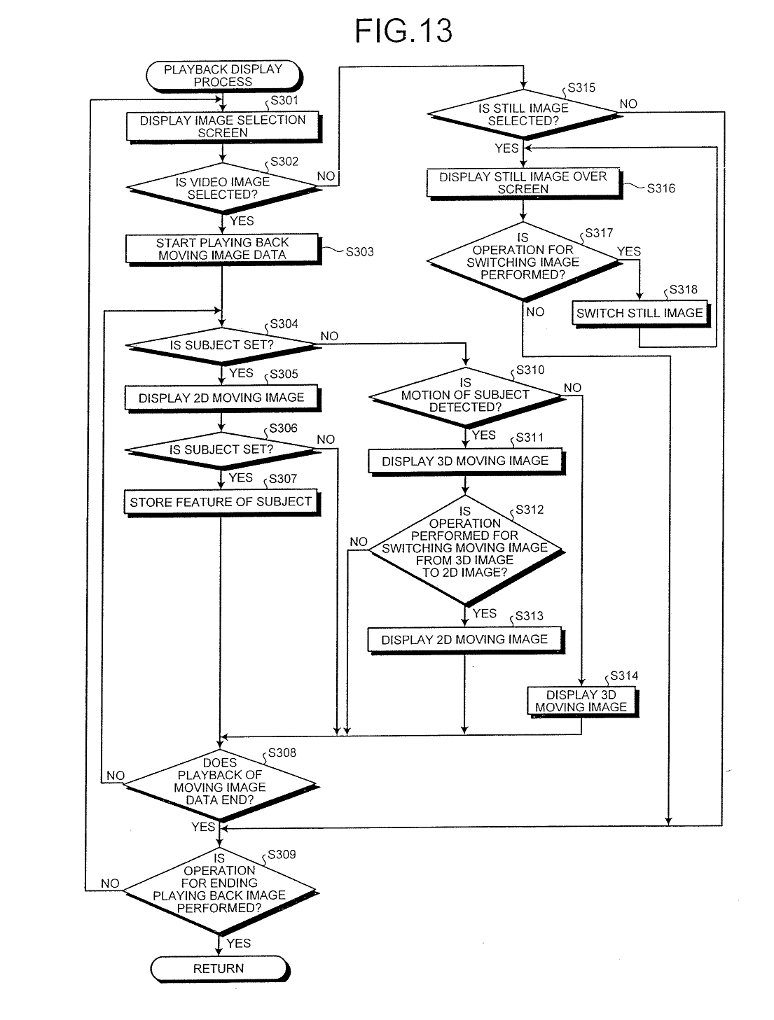

The playback display process at step S110 in FIG. 7 will be described. FIG. 13 is a flowchart of an overview of the playback display process.

In FIG. 13, first, the display controller 95 causes the display unit 6 to display an image selection screen that collectively displays multiple images stored in the image data storage unit 81 (step S301).

Subsequently, the control unit 9 determines whether the user operates the touch panel 7 so that a moving image is selected from the image selection screen, which is displayed by the display unit 6, according to a signal received by the touch panel 7 (step S302). When a moving image is selected from the image selection screen according to the signal received by the touch panel 7 (YES at step S302), the display apparatus 1 goes to step S303, which will be described below. In contrast, when a moving image is not selected from the image selection screen according to a signal received by the touch panel 7 (NO at step S302), the display apparatus 1 goes to step S315, which will be described below.

At step S303, the display controller 95 starts playing moving image data by causing the display unit 6 to display the moving image, which is selected by the signal received by the touch panel 7, and the control unit 9 determines whether a subject of which motion is to be tracked in moving images, which are displayed by the display unit 6, is set according to a signal that is received by the touch panel 7 (step S304). When a subject of which motion is to be tracked in moving images displayed by the display unit 6 is set according to a signal that is received by the touch panel 7 (YES at step S304), the display controller 95 causes the display unit 6 to display, as a 2D image, the moving image that is selected according to the signal received by the touch panel 7 (step S305). Specifically, the display controller 95 causes the display unit 6 to display a moving image corresponding to any one of the right-eye image data and the left-eye image data that are contained in the moving image data.

Subsequently, the control unit 9 determines whether a subject is set according to an input signal received by the touch panel 7 (step S306). When a subject is not set according to an input signal received by the touch panel 7 (NO at step S306), the display apparatus 1 goes to step S308, which will be described below. In contrast, when a subject is set according to a signal received by the touch panel 7 (YES at step S306), the control unit 9 causes the feature information storage unit 84 to store the features of the subject, which is set according to the signal received by the touch panel 7 (step S307) and the display apparatus 1 goes to step S308, which will be described below.

At step S308, the control unit 9 determines whether a set of moving image data displayed by the display unit 6 has ended. When a set of moving image data has not ended (NO at step S308), the display apparatus 1 returns to step S304. In contrast, when a set of moving image data ends (YES at step S308), the display apparatus 1 goes to step S309.

Subsequently, the control unit 9 determines whether the user performs an operation for ending playing of an image (step S309). Specifically, the controller determines whether the user operates the changeover switch 43 so that a switch signal is input giving an instruction to switch the display apparatus 1 to the shooting mode. When the user does not perform an operation for ending playing of an image (NO at step S309), the display apparatus 1 returns to step S301. In contrast, when the user performs an operation for ending playing of an image (YES at step S309), the display apparatus 1 returns to the main routine in FIG. 7.

A case at step S304 will be described where a subject of which motion is to be tracked in moving images, which are displayed by the display unit 6, is not set according to a signal received by the touch panel 7 (NO at step S304). In this case, the control unit 9 determines whether the motion detector 94 detects motion of the subject, which is set according to the signal received by the touch panel 7 (step S310). When the motion detector 94 detects motion of the subject, which is set according to the signal received by the touch panel 7 (YES at step S310), the display controller 95 causes the display unit 6 to display a moving image as a 3D image in which the subject virtually protrudes in a direction orthogonal to the display panel 62 (step S311).

Subsequently, the control unit 9 determines whether the user performs a switch operation for switching the moving image, which is displayed by the display unit 6, from the 3D image to a 2D image (step S312). When the user does not perform a switch operation (NO at step S312), the display apparatus 1 goes to step S308. In contrast, when the user performs a switch operation (YES at step S312), the display controller 95 switches the moving image, which is displayed by the display unit 6, from the 3D image to a 2D image and causes the display unit 6 to display a 2D moving image (step S313) and the display apparatus 1 goes to step S308.

A case at step S310 will be described where the motion detector 94 does not detect any motion of the subject, which is set according to the signal received by the touch panel 7 (NO at step S310). In this case, the display controller 95 causes the display unit 6 to display a 2D moving image (step S314) and the display apparatus 1 goes to step S308.

A case at step S302 will be described where the user does not operate the touch panel 7 and therefore a moving image is not selected from the image selection screen, which is displayed by the display unit 6 (NO at step S302). In this case, the control unit 9 determines whether the user operates the touch panel 7 so that a still image is selected from the image selection screen, which is displayed by the display unit 6, according to an input signal received by the touch panel 7 (step S315). When a still image is not selected from the image selection screen, which is displayed by the display unit 6, according to a signal received by the touch panel 7 (NO at step S315), the display apparatus 1 goes to step S309. In contrast, when a still image is selected from the image selection screen, which is displayed by the display unit 6, according to a signal received by the touch panel 7 (YES at step S315), the display controller 95 causes the display unit 6 to display, over the display unit 6, the still image selected according to the signal received by the touch panel 7 (step S316).

The control unit 9 then determines whether the user performs a switch operation for switching the still image that is currently displayed by the display unit 6 (step S317). When the user performs a switch operation (YES at step S317), the display controller 95 switches the currently displayed still image to the next still image, which is stored in the image data storage unit 81, and causes the display unit 6 to display the still image (step S318) and the display apparatus 1 returns to step S316. In contrast, when the user does not perform a switch operation after a predetermined time, for example, 30 seconds (NO at step S317), the display apparatus 1 goes to step S309.

According to the above-described first embodiment, when the motion detector 94 detects motion of the subject, the display controller 95 causes the display unit 6 to display a 3D moving image or a 3D live view image in which the subject protrudes virtually in a direction orthogonal to the display screen of the display unit 6. Accordingly, the user can see the moving image as an impressive 3D image only when the subject moves. This prevents a moving image or a live view image, which is played back on the display unit 6, from being monotonous.

In the first embodiment, the display controller 95 performs a display in which the subject virtually protrudes in a direction orthogonal to the display screen of the display unit 6 and is thus enhanced. Accordingly, the user can see a 3D image in which the subject and the background are well distinguishable.

In the first embodiment, when the subject stops moving, the display controller 95 displays, as a 2D image, a live view image that is displayed during image-capturing in the shooting mode of the display apparatus 1. Accordingly, it is satisfactory if the display controller 95 outputs, to the display unit 6, any one of image data generated by the first imaging unit 21 and image data generated by the second imaging unit 22. Thus, drive power that is output to any one of the first imaging unit 21 and the second imaging unit 22 can be stopped, which significantly reduces power consumption compared with a case where a 3D image is always displayed.

In the first embodiment, the imaging unit 2 generates two types of image data where one horizontal ends of two fields of view match. For example, the imaging unit 2 may include only one imaging unit and, by sequentially capturing images using the imaging unit, may generate two types of image data where one horizontal ends of two fields of view match. Specifically, two types of image data where one horizontal ends of two fields of view match may be generated in a way that the user sequentially captures images of the subject while moving (swinging) the display apparatus 1 horizontally.

In the above-described first embodiment, the imaging unit 2 generates two types of image data where horizontal one ends of two fields of view match. For example, the imaging unit 2 may include only one imaging unit and, by focusing light using two optical systems on an imaging area of the imaging element, may generate two types of image data where one horizontal ends of two fields of view match. In this case, the two optical systems may be configured to be detachable from the body of the display apparatus 1.

### Second Embodiment

A second embodiment of the present invention will be described below. In the above-described first embodiment, the imaging unit includes the first imaging unit and the second imaging unit, and the display unit is caused to display a 3D image using two types of image data where one horizontal ends of two fields of view, which are generated respectively by the first imaging unit and the second imaging unit. In the second embodiment, one imaging unit sequentially generates image data and a display unit is caused to display a 3D image using two types of chronologically successive image data. The display apparatus of the second embodiment has the same configuration as that of the first embodiment excluding the imaging unit and the display controller. In the second embodiment, after the imaging unit and the display controller are described, a method in which the display controller displays a 3D image will be described.

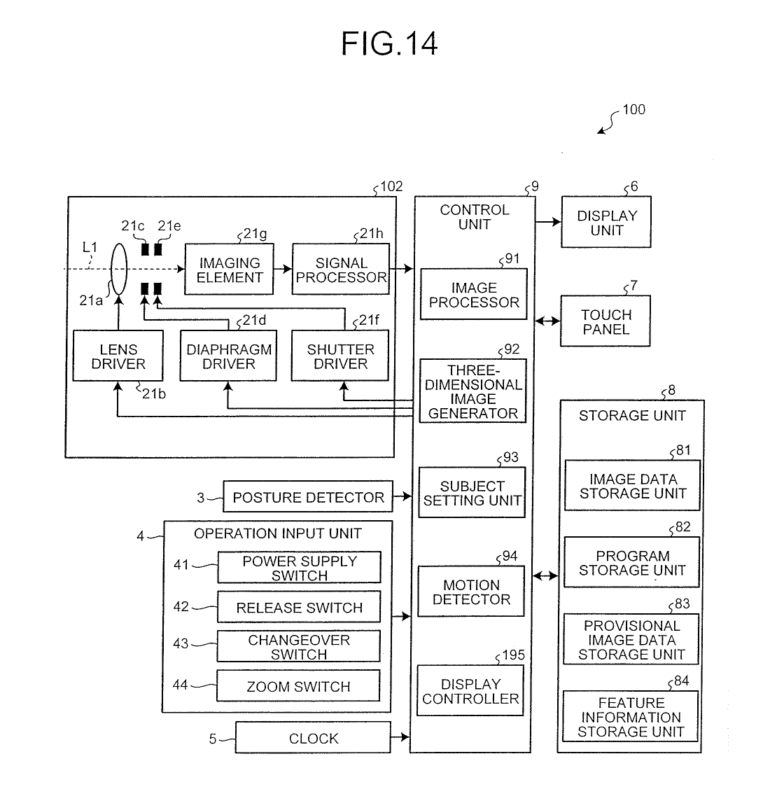

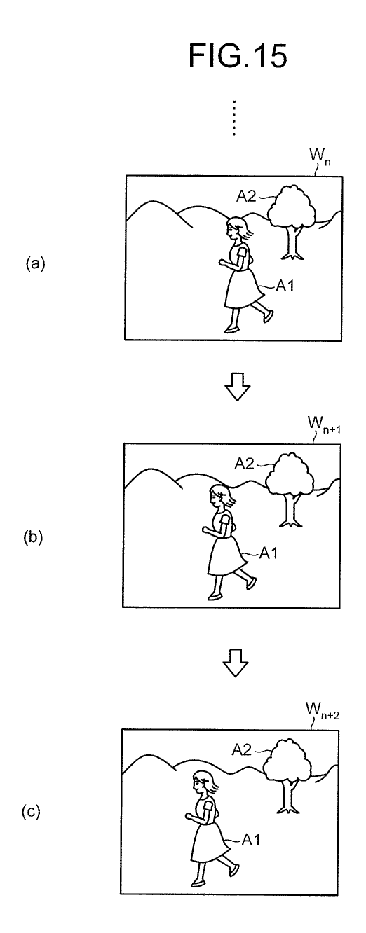

FIG. 14 is a block diagram of a configuration of the display apparatus according to the second embodiment. The same elements in FIG. 14 as those of the display apparatus 1 described in the first embodiment are denoted by the same reference numerals, and thus descriptions thereof will be omitted below.

As illustrated in FIG. 14, a display apparatus 100 includes an imaging unit 102 that captures images of a subject and generates electric image data of the subject of which images are captured; and a display controller 195 that causes the display unit 6 to display a 3D image or a 2D image.

The imaging unit 102 is realized by using the same configuration as that of the first imaging unit 21 of the first embodiment. The imaging unit 102 includes the lens unit 21a, the lens driver 21b, the diaphragm 21c, the diaphragm driver 21d, the shutter 21e, the shutter driver 21f, the imaging element 21g, and the signal processor 21h.

The display controller 195 causes the display unit 6 to display a 3D image or a 2D image. Specifically, the display controller 195 causes the display unit 6 to display a 3D image by outputting two types of chronologically successive image data, which are stored by the provisional image data storage unit 83, such that each pixel is alternately arranged horizontally on the display screen of the display unit 6.

A method will be described that is performed by the display apparatus 100 having the above-described configuration in which the display controller 195 causes the display unit 6 to display a 3D image. FIG. 15 contains diagrams of chronological images corresponding to multiple types of image data that, when the display apparatus 100 captures moving images, the imaging unit 102 sequentially generates. FIG. 15 shows three representative images Wₙ to Wₙ₊₂ (n is an integer) from multiple types of image data that the imaging unit 102 sequentially generates when the display apparatus 100 captures moving images of the subject A1. The images Wₙ to Wₙ₊₂ are chronologically successive images.

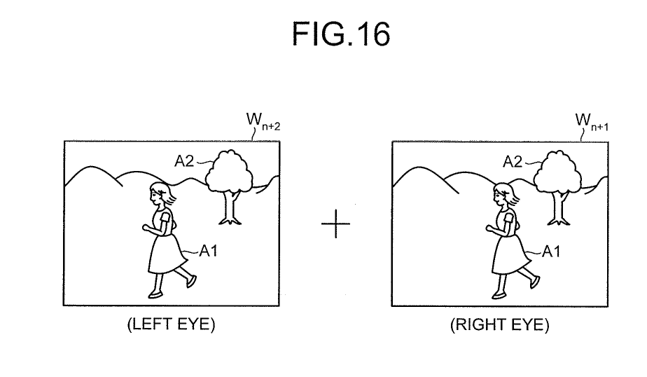

As illustrated in FIG. 15, when the subject A1 moves leftward from the center part of the image (see (a) to (c) of FIG. 15), the positional relationship between the subject A1 and the subject A2 (background) changes over time. In other words, as described in the first embodiment, when the image Wₙ and the image Wₙ₊₁ are virtually superimposed, the areas of the subject A2 match. In contrast, the areas of the subject A1 do not match and thus there is a parallax with respect to the subject A1. Furthermore, the distance between the subject A1 and the subject A2 increases over time. As illustrated in FIG. 16, the display controller 195 causes the display unit 6 to display a 3D image in which the subject virtually protrudes in a direction orthogonal to the display screen of the display unit 6 by using, as a right-eye image, the image Wₙ₊₁ (past image) captured just before the subject A1 starts moving and using, as a left-eye image, the image Wₙ₊₂ captured after the subject A1 moves.

As described above, the display controller 195 causes the display unit 6 to display a 3D image by using chronologically successive image data that is stored in the provisional image data storage unit 83. Accordingly, as in the case of the first embodiment, the user can see a 3D image in which the subject A1 protrudes virtually in a direction orthogonal to the display screen of the display unit 6. FIG. 15 illustrates the case in which the subject A1 moves leftward in the images. If the subject A1 moves rightward in images, the display controller 195 causes the display unit 6 to display a 3D image by using, as a left-eye image, an image captured just before the subject A1 starts moving and using, as a right-eye image, an image captured after the subject A1 moves. According to the rate at which the subject A1 moves, the display controller 195 may adjust the distance by which a 3D image virtually protrudes in a direction orthogonal to the display screen of the display unit 6. Accordingly, the user can see a more realistic 3D image.

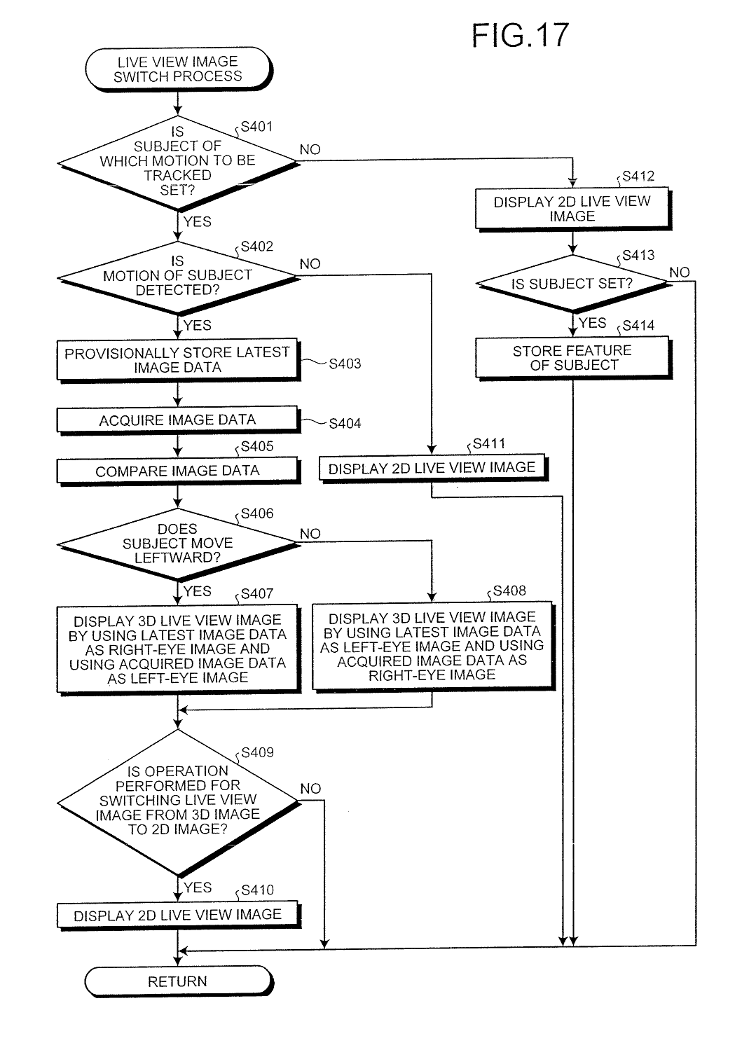

An overview of processes performed by the display apparatus 100 according to the second embodiment will be described. The display apparatus 100 according to the second embodiment performs the same processes, excluding the live view image switch process, as those performed by the display apparatus 1 according to the first embodiment. Thus, only a live view image switch process performed by the display apparatus 100 according to the second embodiment will be described below. FIG. 17 is a flowchart of an overview of the live view image switch process performed by the display apparatus 100 according to the second embodiment.

As illustrated in FIG. 17, first, the control unit 9 determines whether a subject of which motion is to be tracked in live view images, which are displayed by the display unit 6, is set according to a signal received by the touch panel 7 (step S401). When a subject of which motion is to be tracked in live view images, which are displayed by the display unit 6, is set according to a signal received by the touch panel 7 (YES at step S401), the control unit 9 determines whether the motion detector 94 detects motion of the subject, which is set according to the signal received by the touch panel 7 (step S402). When the motion detector 94 detects motion of the subject, which is set according to the signal received by the touch panel 7 (YES at step S402), the display apparatus 100 goes to step S403, which will be described below. In contrast, when the motion detector 94 does not detect any motion of the subject, which is set according to the signal received by the touch panel 7 (NO at step S402), the display apparatus 100 goes to step S411.

At step S403, the control unit 9 causes the provisional image data storage unit 83 to store the latest image data that is sequentially generated at a predetermined small time interval (step S403) and the control unit 9 acquires data of images that the imaging unit 102 is capturing (step S404).

The control unit 9 then compares the latest image data and the acquired image data (step S405) and determines whether the subject moves leftward in the images (step S406). Specifically, the control unit 9 determines whether the subject moves leftward in the images as illustrated in FIG. 15. When the subject moves leftward in the images (YES at step S406), the display controller 195 causes the display unit 6 to display a 3D live view image by using the latest image data as a right-eye image and using the acquired image data as a left-eye image (step S407) and the display apparatus 100 goes to step S409, which will be described below.

In contrast, when the subject does not move leftward in the images (NO at step S406), the display controller 195 causes the display unit 6 to display a 3D live view image by using the latest image data as a left-eye image and using the acquired image data as a right-eye image (step S408) and the display apparatus 100 goes to step S409.

At step S409, the control unit 9 determines whether the user performs a switch operation for switching the live view image, which is displayed by the display unit 6, from the 3D image to a 2D image (step S409). Specifically, the control unit 9 determines whether the user operates the changeover switch 43 so that a switch signal is input giving an instruction to switch the live view image, which is displayed by the display unit 6, from the 3D image to a 2D image. When the user does not perform a switch operation for switching the live view image, which is displayed by the display unit 6, from the 3D image to a 2D image (NO at step S409), the display apparatus 100 returns to the main routine in FIG. 7. In contrast, when the user performs a switch operation for switching the live view image, which is displayed by the display unit 6, from the 3D image to a 2D image (YES at step S409), the display controller 195 causes the display unit 6 to display a 2D live view image by using the image data, which is sequentially generated by the imaging unit 102 at the predetermined time interval (step S410), and the display apparatus 100 returns to the main routine in FIG. 7.

A case at step S402 will be described where the motion detector 94 does not detect any motion of the subject, which is set according to the signal received by the touch panel 7 (NO at step S402). In this case, the display controller 195 causes the display unit 6 to display a 2D live view image corresponding to the image data, which is sequentially generated by the imaging unit 102 at the predetermined small time interval (step S411), and the display apparatus 100 returns to the main routine in FIG. 7.

A case at step S401 will be described where a subject of which motion is to be tracked in live view images, which are displayed by the display unit 6, according to a signal received by the touch panel 7 (NO at step S401). In this case, the display controller 195 causes the display unit 6 to display a 2D live view image corresponding to the image data, which is sequentially generated by the imaging unit 102 at the predetermined small time interval (step S412).

The control unit 9 then determines whether the subject setting unit 93 sets a subject according to an input signal received by the touch panel 7 (step S413). When the subject setting unit 93 does not set a subject according to an input signal received by the touch panel 7 (NO at step S413), the display apparatus 100 returns to the main routine in FIG. 7. In contrast, when the subject setting unit 93 sets a subject according to an input signal received by the touch panel 7 (YES at step S413), the feature information storage unit 84 is caused to store the features of the subject, which is set by the subject setting unit 93 (step S414), and the display apparatus 1 returns to the main routine in FIG. 7.

In the above-described second embodiment, when the motion detector 94 detects motion of the subject, the display controller 195 causes the display unit 6 to display a 3D moving image or a 3D live view image, in which the subject virtually protrudes in a direction orthogonal to the display screen of the display apparatus, by using the two types of chronologically successive image data, which are stored in the provisional image data storage unit 83. Accordingly, as in the case of the first embodiment, the user can see a moving image as a 3D image only when the subject moves. This prevents played moving images from being monotonous.

Furthermore, in the second embodiment, the display controller 195 causes the display unit 6 to display a 3D image by using image data, which is sequentially generated by only the single imaging unit 102. Thus, the display apparatus can have a simple configuration when compared with a display apparatus that includes two imaging units.

### Other Embodiments

In the first embodiment, the display controller 95 causes the display unit 6 to display a 3D image when the subject set by the user exists in images and the subject moves. Alternatively, when the subject set by the user enters (exists) in the area of the field of view of the imaging unit 2, the display controller 95 may switch from a 2D image to a 3D image and cause the display unit 6 to display a 3D moving image or a 3D live view image. Thus, when the subject enters the area of the field of view of the imaging unit 2, the display controller 95 causes the display unit 6 to display a 3D image in which the subject virtually protrudes in a direction orthogonal to the display screen of the display unit 6, which attracts the attention of the viewer. If such a mode is used, a display is made in which a 3D image protrudes on, for example, a monitor camera when a certain subject or an object enters. Thus, the user can acquire more detailed features and data on the subject and thus can further utilize the information contained in the 3D image. This embodiment can be applied to the second embodiment.

In the first embodiment, the display controller 95 causes the display unit 6 to display a 3D image when the subject set by the user exists in images and the subject moves. For example, the image may be switched from a 2D image to a 3D image and then displayed when a character moves that appears in an image displayed by a display monitor of a game machine or an amusement device. Accordingly, a 3D image can be displayed in accordance with the mode of the character of the game, for example, the battle mode; therefore, the user can have more realistic sensations while operating the game machine. This embodiment can be applied to the second embodiment.

In the first and second embodiments, the posture detector 3 detects the posture of the display apparatus 1. Alternatively, by detecting the acceleration caused when the user taps the display screen of the display unit 6, an operation signal of a tap operation for switching between various shooting modes or various settings of the display apparatus 1 may be received and the operation signal may be output to the control unit 9.

In the first and second embodiments, the display unit 6 employs a parallax barrier system. However, it is satisfactory if the user can see a 3D image three-dimensionally. Thus, a lenticular system may be employed.

In the first and second embodiments, the display apparatuses 1 and 100 are described as digital still cameras. Alternatively, various electric devices having an image-capturing function and a display function, such as a digital video camera or a mobile phone with a camera, or various electric devices having a display function, such as a digital photo frame or an electric viewer, may be used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display apparatus comprising:
a display unit that displays moving images corresponding to moving image data that is made up of multiple two-dimensional images and three-dimensional images that are sequentially generated chronologically;
a touch panel that is provided on a display screen of the display unit and that receives an input of a signal corresponding to a position touched by an external object;
a setting unit that sets, as a subject of which motion is to be tracked in the moving images displayed by the display unit, a subject that is contained in the moving images and that is specified according to an input signal that is received by the touch panel;
a motion detector that, when the subject setting unit sets the subject to be tracked, detects motion of the subject, which is set by the subject setting unit, on the basis of successive two of the two-dimensional images or the three-dimensional images that are generated chronologically; and
a display controller that, when the motion detector detects the motion of the subject to be tracked, causes the display unit to display the three-dimensional images as the moving images.

2. The display apparatus according to claim 1, further comprising a background separator that separates, as a subject image, the subject to be tracked, which is set by the subject setting unit, from a background image in the moving image,
wherein, while the display controller causes the display unit to display the subject image separated by the background separator, as the three-dimensional image, the display controller causes the display unit to display the background image as the two-dimensional image.

3. The display apparatus according to claim 2, further comprising:
an imaging unit that captures images of a subject in different positions and sequentially generates two types of two-dimensional image data where horizontal one ends of two fields of view match; and
a three-dimensional image generator that generates the three-dimensional image by cutting out an image with a predetermined aspect ratio from each of two images corresponding respectively to the two types of two-dimensional image data,
wherein the display controller causes the display unit to display the three-dimensional image, which is generated by the three-dimensional image generator, by outputting the three-dimensional image such that each pixel is alternately arranged horizontally on the display screen of the display unit.

4. The display apparatus according to claim 2, further comprising:
an imaging unit that sequentially generates two-dimensional image data of the subject; and
a provisional storage unit that temporarily stores the two-dimensional image data, which is generated by the imaging unit,
wherein the display controller causes the display unit to display the three-dimensional image by outputting the chronologically-successive two types of two-dimensional image data, which are stored in the provisional storage unit, such that each pixel is alternately arranged horizontally on the display screen of the display unit.

5. A display apparatus comprising:
a display unit that selectively displays two-dimensional moving images and three-dimensional moving images;
a motion detector that detects motion of a subject contained in the moving images; and
a display controller that, when the motion detector detects the motion of the subject contained in the two-dimensional moving images being displayed by the display unit, causes the display unit to display the three-dimensional moving images as the moving images.

6. The display apparatus according to claim 5, further comprising:
a touch panel that is provided on a display screen of the display unit and that receives an input of a signal corresponding to a position touched by an external object; and
a setting unit that sets, as a subject of which motion is to be tracked in the moving images displayed by the display unit, a subject that is contained in the moving images and that is specified according to an input signal that is received by the touch panel, wherein
the motion detector detects, when the subject setting unit sets the subject to be tracked, the motion of the subject which is set by the subject setting unit, on the basis of successive two of the two-dimensional images or the three-dimensional images that are generated chronologically, and
the display controller causes, when the motion detector the motion of the subject to be tracked, the display unit to display the three-dimensional images as the moving images.

7. The display apparatus according to claim 6, further comprising a background separator that separates, as a subject image, the subject to be tracked, which is set by the subject setting unit, from a background image in the moving image,
wherein, while the display controller causes the display unit to display the subject image separated by the background separator, as the three-dimensional image, the display controller causes the display unit to display the background image as the two-dimensional image.

8. The display apparatus according to claim 7, further comprising:
an imaging unit that captures images of a subject in different positions and sequentially generates two types of two-dimensional image data where horizontal one ends of two fields of view match; and
a three-dimensional image generator that generates the three-dimensional image by cutting out an image with a predetermined aspect ratio from each of two images corresponding respectively to the two types of two-dimensional image data,
wherein the display controller causes the display unit to display the three-dimensional image, which is generated by the three-dimensional image generator, by outputting the three-dimensional image such that each pixel is alternately arranged horizontally on the display screen of the display unit.

9. The display apparatus according to claim 7, further comprising:
an imaging unit that sequentially generates two-dimensional image data of the subject; and
a provisional storage unit that temporarily stores the two-dimensional image data, which is generated by the imaging unit,
wherein the display controller causes the display unit to display the three-dimensional image by outputting the chronologically-successive two types of two-dimensional image data, which are stored in the provisional storage unit, such that each pixel is alternately arranged horizontally on the display screen of the display unit.

10. A display apparatus comprising:
a display unit that selectively displays two-dimensional moving images and three-dimensional moving images;
a motion detector that detects motion of a subject contained in the moving images; and
a display controller that, when the motion detector detects the motion of the subject contained in the two-dimensional moving images being displayed by the display unit, converts the two-dimensional moving images into the three-dimensional moving images and causes the display unit to display the three-dimensional moving images as the moving images.

11. The display apparatus according to claim 10, further comprising:
a touch panel that is provided on a display screen of the display unit and that receives an input of a signal corresponding to a position touched by an external object; and
a setting unit that sets, as a subject of which motion is to be tracked in the moving images displayed by the display unit, a subject that is contained in the moving images and that is specified according to an input signal that is received by the touch panel, wherein
the motion detector detects, when the subject setting unit sets the subject to be tracked, the motion of the subject which is set by the subject setting unit, on the basis of successive two of the two-dimensional images or the three-dimensional images that are generated chronologically, and
the display controller causes, when the motion detector the motion of the subject to be tracked, the display unit to display the three-dimensional images as the moving images.

12. The display apparatus according to claim 11, further comprising a background separator that separates, as a subject image, the subject to be tracked, which is set by the subject setting unit, from a background image in the moving image,
wherein, while the display controller causes the display unit to display the subject image separated by the background separator, as the three-dimensional image, the display controller causes the display unit to display the background image as the two-dimensional image.

13. The display apparatus according to claim 12, further comprising:
an imaging unit that captures images of a subject in different positions and sequentially generates two types of two-dimensional image data where horizontal one ends of two fields of view match; and
a three-dimensional image generator that generates the three-dimensional image by cutting out an image with a predetermined aspect ratio from each of two images corresponding respectively to the two types of two-dimensional image data,
wherein the display controller causes the display unit to display the three-dimensional image, which is generated by the three-dimensional image generator, by outputting the three-dimensional image such that each pixel is alternately arranged horizontally on the display screen of the display unit.

14. The display apparatus according to claim 12, further comprising:
an imaging unit that sequentially generates two-dimensional image data of the subject; and
a provisional storage unit that temporarily stores the two-dimensional image data, which is generated by the imaging unit,
wherein the display controller causes the display unit to display the three-dimensional image by outputting the chronologically-successive two types of two-dimensional image data, which are stored in the provisional storage unit, such that each pixel is alternately arranged horizontally on the display screen of the display unit.
